(19) United States
(12) Patent Application Publication
(10) Pub. No.: US 2015/0125687 A1
(43) Pub. Date: May 7, 2015

(54) SUBSTRATE WITH ELECTRICALLY CONDUCTIVE COATING AS WELL AS METHOD FOR PRODUCING A SUBSTRATE WITH AN ELECTRICALLY CONDUCTIVE COATING

(71) Applicant: SCHOTT AG, Mainz (DE)

(72) Inventor: Annelie Gabriel, Klein-Winternheim (DE)

(21) Appl. No.: 14/532,522

(22) Filed: Nov. 4, 2014

(30) Foreign Application Priority Data
Nov. 4, 2013 (DE) 10 2013 112 109.8

(51) Int. Cl. H01B 1/24; H01B 1/18; H01B 13/30; C09D 5/24

(52) U.S. Cl. CPC H01B 1/24; C09D 5/24; H01B 1/18; H01B 13/30
USPC 428/323; 252/502; 252/511; 427/122

(57) ABSTRACT

A method for producing a temperature-resistant, electrically conductive coating on a substrate is provided. The method includes at least the steps of providing a binding agent, the binding agent having an inorganically crosslinked, SiO₂-containing binding-agent matrix; producing a dispersion of an electrically conductive pigment in the binding agent by mechanical convection, wherein the fraction of electrically conductive pigment amounts to 10 to 40 wt. %, and carbon is used as the electrically conductive pigment; partial, structured printing of the coating material obtained by dispersion onto the substrate; and drying the obtained coating at temperatures in the range of 20 to 250° C. Also provided are preparations for producing an electrically conductive coating on a substrate as well as substrates provided with electrically conductive coatings.

### CROSS REFERENCE TO RELATED APPLICATIONS

This application claims benefit under 35 U.S.C. §119(a) of German Patent Application No. 10-2013-112-109.8, filed Nov. 4, 2013, the entire contents of which are incorporated herein by reference.

### BACKGROUND

1. Field of the Invention

In general, the invention relates to substrates with electrically conductive coating as well as a method for producing a corresponding coating compound as well as a substrate coated therewith. In particular, the invention relates to glass or glass-ceramic substrates having an electrically conductive coating as well as a corresponding coating compound as well as a production method.

2. Description of Related Art

Electrically conductive coatings on glass or glass-ceramic substrates that are employed, for example, as electrical circuits for touch panels, are known from the prior art. In particular, these coatings are increasingly used for controlling glass-ceramic cooktops, for example, for controlling induction cookers.

The use of transparent glass ceramics as cooktops has been increasingly established due to the plurality of possible designs and configurations. These cooktops can be provided with different coatings in order to obtain the desired design and to conceal the components underneath the cooking surface. Usually, for this purpose, the glass ceramics are first provided for the most part with a colored coating, frequently with a sol-gel-based coating, and then with a sealing layer. In this case, the sealing layer, in particular, can be a silicone-based layer and is introduced at burning-in temperatures of 200 to 250° C.

If these types of glass-ceramic cooktops are also to have an electrically conductive layer, for example, for controlling a touch panel, this layer is introduced as a third layer or is introduced after applying decorative and sealing layers. However, this necessitates burning-in temperatures below 250° C., in order not to damage the decorative and sealing layers.

Electrically conductive coatings that contain precious metals, for example, gold or silver, and are introduced onto the substrate by means of glass flux at temperature of above 550° C. are known from the prior art. Thus, JP 2006 054091 A1 describes a metal-based, conductive coating on a glass substrate. In this case, the glass substrate is coated with a coating compound made of metal, organic binder and glass flux, and the coating is burned-in at temperatures of 550 to 900° C. Apart from the high cost of raw material for these coatings, the high burning-in temperatures have increasingly been demonstrated to be a disadvantage.

In addition, electrically conductive coatings based on carbon are known from the prior art. Different polymers, such as, for example, modified polyurethanes, polyacrylates, polyvinyl chloride or polycarbonates are used here as binding agents. These types of coatings, however, are not temperature-resistant, or at least are not sufficiently temperature-resistant, due to the binding agents used, so that such coatings cannot be used in high-temperature applications, for example, as a coating on cooktops.

Patent Application WO 2006 128403 A1 describes electrically conductive pigments, such as carbon black, CNTs, fullerene or graphite, which are introduced in non-electrically conducting binders, such as polyurethane, polyacrylate or polycarbonate.

A carbon paste that is composed of spherical and flake-shaped graphite particles and acetylene black in a polyester resin as the binding agent is described in Japanese Patent JP 433 33 58 B1. In order to ensure a sufficient electrical conductivity, the fraction of electrically conducting pigments amounts to 45 to 60%.

Electrically conductive coatings having a binding agent based on plastic in fact make possible low burning-in temperatures, but the corresponding coatings have a relatively low temperature resistance of 150 to 250° C.

Another possibility consists in the use of a binding agent based on sol-gel. The rheological properties of this binding agent require, on the one hand, however, very high shearing forces for the homogeneous distribution of electrically conductive fillers, which may damage the fillers and can act disadvantageously on the electrical conductivity; on the other hand, for the most part, additional rheology and control agents are required in order to ensure the printability of the coating compound.

### SUMMARY

An object of the invention thus consists in providing a method for producing an electrically conductive, permanently temperature-resistant coating, which does not have the above-mentioned disadvantages. In particular, an object of the invention is to provide a method for producing an electrically conductive, permanently temperature-resistant coating that has a good electrical conductivity even with low burning-in temperatures. “Permanently temperature-resistant coating” here is particularly understood to be a coating that is stable under a constant temperature load at temperatures of at least 300° C., preferably of up to 500° C.

Another object of the invention consists in providing a corresponding printable coating compound and in providing a substrate with a temperature-resistant, electrically conductive coating.

The method for producing an electrically conductive coating on a substrate comprises at least the following steps: Providing a binding agent, whereby the binding agent contains an inorganically crosslinked, SiO₂-containing binding-agent matrix and a solvent; Producing a dispersion of an electrically conductive pigment in the binding agent by mechanical convection, in particular with the use of a stirrer, wherein the fraction of electrically conductive pigment amounts to 10 to 40 wt. %, and carbon is used as the electrically conductive pigment; Partial, structured printing of the coating compound obtained by dispersion of the electrically conductive pigment in the binding agent onto the substrate; Drying the obtained coating at temperatures in the range of 20 to 250° C.

In a variant, the binding agent involves a sol-gel-based binding agent. Thus, the binding agent has an inorganically crosslinked sol-gel network as the binding-agent matrix.

According to an enhancement of the invention, the sol-gel binding agent is provided by hydrolysis, so that in this enhancement of the invention, the production method comprises the following additional method steps for providing the binding agent: Producing a sol-gel binding agent as a hydrolysate by hydrolysis of a monomer with water, whereby a low-boiling alcohol is formed as a liquid condensation product, and the degree of inorganic crosslinking of the hydrolysate is adjusted by the ratio of water to monomer; and Exchanging the alcohol formed in step a) for a solvent with a vapor pressure of <5 bars, a boiling point >120°, and/or an evaporation number >10.

First, the binding agent is produced in the first step. In this case, it is a sol-gel-based binding agent, which is obtained by hydrolysis of a monomer. A metal alkoxide is preferably used as the sol-gel monomer, preferably alkoxysilanes, for example, tetraethoxysilane (TEOS), aluminum alkoxides, titanium alkoxides, zirconium alkoxides, and/or organometallic alkoxides. In addition, a tetraalkoxysilane Si(OR¹)₄ (with R¹=methyl, ethyl, propyl, iso-propyl, butyl, sec. butyl or phenyl) or an aluminum alkoxide or a titanium alkoxide or a zirconium alkoxide can be used in combination with an alkoxysilane Si(OR¹)₃R² that possesses an organically crosslinkable functionality (R²=alkyl chain functionalized with glycidoxy, methacryloxy, acryl, vinyl, allyl, amino, mercapto, isocyanato, epoxy, acrylate or methacrylate. Organically crosslinkable alkoxysilanes may be, for example: glycidyoxypropyltriethoxysilane (GPTES), methacryloxypropyltriethoxysilane (MPTES), glycidyloxypropyltrimethoxysilane (GPTMS), methacryloxypropyltrimethoxysilane MPTMS), vinyltriethoxysilane (VTES), allyltriethoxysilane (ATES), aminopropyltriethoxysilane (APTES), mercaptopropyltriethoxysilane (MPTES), 3-isocyanatopropyltriethoxysilane (ICPTES). Yet another metal alkoxide can be used alternatively, for example, zirconium tetrapropoxide (Zr(OR¹)₄), titanium tetraethoxide (Ti(OR¹)₄) or aluminum secondary butoxide (Al(OR¹)₃). Alternatively, yet another organoalkoxysilane is used, for example, Si(OR¹)₃R³, Si(OR¹)₂R³₂, Si(OR¹)R³₃ (with R¹=methyl, ethyl, propyl, butyl, sec. butyl; R³: methyl, phenyl, ethyl, iso-propyl, butyl, sec. butyl), for example, methyltriethoxysilane (MTEOS), phenyltriethoxysilane (PhTEOS), dimethyldiethoxysilane (DEMDEOS). The (sol-gel) hydrolysate is produced by the targeted reaction of the monomers with water. This is carried out preferably in the presence of an acid, for example, hydrochloric acid, sulfuric acid, paratoluenesulfonic acid, acetic acid. The aqueous hydrolysis solution preferably has a pH<4. In a particular embodiment, the hydrolysis can also be conducted in alkaline medium (e.g., NH₃, NaOH). In another special embodiment, the hydrolysis is conducted with an aqueous dispersion of nanoparticles. The degree of crosslinking of the hydrolysate is adjusted via the ratio of water to hydrolyzable monomers.

The matrix can be dielectric or non-dielectric. In a particular embodiment, the matrix material can also be conductive itself. For example, so-called conjugated polymers can be involved, such as, for example, poly(3,4-ethylenedioxythiophene) poly(styrenesulfonate) (PEDOT/PSS), but above all, temperature-resistant silanes having one or more conductive groups.

The residual solvent content of the hydrolysate is preferably less than 20 wt. %, more preferably, less than 19 wt. %.

According to an embodiment of the invention, a trialkoxysilane and/or a tetraalkoxysilane is (are) used as the sol-gel monomer. By using a mixture of several alkoxysilanes, for example, a mixture of a trialkoxysilane and a tetraalkoxysilane, an inorganic-organic hybrid network with organic groups can be obtained. In a preferred embodiment, tetraethoxysilane (TEOS) and/or methyltriethoxysilane (MTEOS) are used as monomers.

However, only one monomer may also be used. Thus, in one embodiment of the invention, a tetraalkoxysilane can be used as the sole monomer. A purely inorganically crosslinked sol-gel network with only a very small fraction of organic groups will be formed thereby.

Hydrolysis takes place in the presence of a catalyst. In particular, the hydrolysis is acid catalyzed, whereby an acid, for example, hydrochloric acid or para-toluenesulfonic acid, is added.

The desired inorganic degree of crosslinking of the hydrolysate or of the binding-agent matrix formed by the hydrolysis reaction of the monomers or of the monomer with water in this case can be adjusted by the ratio of monomer to water.

In an embodiment, the inorganic crosslinking degree of the binding-agent matrix or of the sol-gel network amounts to 40 to 90%, preferably 50 to 80%, and more preferably 60 to 80%. A lower degree of crosslinking in this case leads to an extended stability of the coating compound. At the same time, for the formation of a stable layer, the degree of crosslinking should not be too low. The inorganic degree of crosslinking in this case is determined by means of ²⁹Si-NMR.

In the second step, the method provides an at least partial exchange of the alcohol formed in first step for a higher-boiling solvent.

In this case the alcohol formed as a liquid condensation product as well as byproducts formed by the hydrolysis reaction are removed at least partially and a high-boiling solvent is added. According to an embodiment, after the exchange, the fraction of liquid condensation product in the binding agent amounts to a maximum of 10 wt. %, preferably a maximum of 5 wt. %.

A printable, in particular, screen-printable paste is obtained by the solvent exchange. In this case, printability is already assured by the solvent exchange or the solvent used, so that another addition of additives such as rheology control agents, for example, can be dispensed with.

In particular, the solvent has a vapor pressure of <5 bars, preferably <1 bar, and more preferably <0.1 bar; a boiling point of >120° C., preferably >150° C., and more preferably >200° C.; and/or an evaporation number of >10, preferably >500, and more preferably >1000. These values have been demonstrated to be advantageous, in particular, relative to the processability of the coating compound in the screen-printing method.

The following are particularly suitable as solvents: glycols, glycol ethers, terpenes and/or polyols, more preferably selected from the group: butyl acetate, methoxybutyl acetate, butyl diglycol, butyl diglycol acetate, cyclohexanone, diacetone alcohol, diethylene glycol, dipropylene glycol monomethyl ether, dipropylene glycol monobutyl ether, propylene glycol monobutyl ether, propylene glycol monopropyl ether, propylene glycol monoethyl ether, ethoxypropyl acetate, hexanol, methoxypropyl acetate, monoethylene glycol, ethyl pyrrolidone, dipropylene glycol monobutyl ether, propylene glycol, propylene glycol monomethyl ether, mixtures of paraffinic and naphthenic hydrocarbons, aromatic hydrocarbon mixture, mixtures of aromatic, alkylated hydrocarbons, mixtures of n-, i-, and cyclo-aliphates, and terpineol. The use of solvent mixtures is also possible.

According to an embodiment of the invention, the solvent can be added both to the hydrolysate produced in first step as well as to the pigmented color, i.e., to the electrically conductive pigment.

In an enhancement of the above-described variants of the invention, the monomer is hydrolyzed in the first step with an aqueous, inorganic nanoparticle dispersion, preferably with an aqueous SiO₂ nanoparticle dispersion. Thus, a binding agent can be obtained, which has a sol-gel binding-agent matrix and inorganic nanoparticles embedded therein. By addition of the nanoparticles as a dispersion already during the hydrolysis, a particularly uniform distribution of the nanoparticles can be achieved. However, it is also possible to disperse the nanoparticles into the sol-gel binding agent in a separate step without departing from the invention.

The coatings produced with the production method according to the invention have a good adherence on the substrate, so that the addition of an adhesion promoter can be dispensed with. However, it is possible to further increase the adherence by the addition of an adhesion promoter without departing from the invention.

According to another enhancement of the invention, an adhesion promoter, preferably an aminosilane and/or a mercaptosilane, is added additionally in the first step. Preferably, the ratio between the sol-gel monomer and the adhesion promoter amounts to 10:1 to 100:1, more preferably 15:1 to 50:1.

Another variant of the invention provides for using a binding agent having a silicone resin-based binding-agent matrix, i.e., the binding agent contains silicone resins as the binding-agent matrix.

The phrase “silicone resins” is to be understood, in particular, as inorganically crosslinked polysiloxanes, for example, polymethylsiloxanes or polyphenylsiloxanes.

Alkyl-modified and/or aryl-modified silicone resins, in particular, methyl-modified and/or phenyl-modified silicone resins, have been demonstrated as particularly advantageous here. Modified silicone resins are to be understood in the sense of the invention, in particular, as those silicone resins that have organic groups or residues, whereby the corresponding groups are covalently bound to silicon atoms of the silicone-resin matrix. In this case, both a mixture of different, modified silicone resins as well as silicone resins that have several different organic groups can be used as the binding-agent matrix.

With the use of modified silicone resins, the properties of the binding-agent matrix as well as the coating produced therefrom can be influenced by the type and quantity of organic groups present in the binding-agent matrix. Thus, for example, by the use of phenyl-modified silicone resins, the temperature resistance of the coating obtained by means of the method according to the invention can be increased.

In addition, the flexibility of the coatings thus obtained can be influenced by the organic groups or residues. The use of a methyl-modified and/or a phenyl-modified silicone resin has been demonstrated here to be particularly advantageous with respect to flexibility as well as temperature resistance of the corresponding coating.

In an enhancement, the silicone resins alternatively or additionally have other functional groups or organic residues. Thus, by use of epoxy-modified or polyester-modified silicone resins, for example, the pigment uptake capacity of the binding-agent matrix can be increased, so that the electrically conductive pigment can be distributed particularly homogeneously in the matrix. Also, for example, epoxy-modified or polyester-modified silicone resins make possible an additional organic crosslinking of the binding-agent matrix via the organic groups.

In the method according to the invention, a dispersion of an electrically conductive pigment in the binding agent is produced, this pigment being carbon in the case of the electrically conductive pigment. In this case, graphite, CNTs or soot are particularly added as the electrically conductive pigment. It has been demonstrated surprisingly that with just the use of a pigment, the coating being obtained has a high electrical conductivity. Preferably, therefore, only one pigment, i.e., not a mixture of different pigments such as a mixture of graphite and carbon nanotubes, for example, is dispersed in the binding agent.

According to a preferred embodiment, graphite particles, in particular, flake-shaped graphite particles are added to the binding agent as the electrically conductive pigment. Based on their shape, which makes possible an alignment of the particles parallel to the substrate surface, the use of flake-shaped graphite particles in this case directly assures a high electrical conductivity of the later coating. “Flake-shaped graphite particles”, in the sense of the invention are also to be understood as graphite particles that have a strongly anisometric, needle-like form. The use of strongly anisometric, needle-shaped graphite particles as the electrically conductive pigment has been demonstrated as particularly advantageous with respect to the electrical conductivity of the later coating.

In particular, flake-shaped graphite particles with an average size d90 of 1 to 100 μm, preferably of 5 to 50 μm, and more preferably of 10 to 25 μm are used.

The fraction of electrically conductive pigment in the coating compound amounts to 10 to 40 wt. %, preferably 10 to 35 wt. %, and more preferably, 12 to 30 wt. %. Due to the comparatively small fraction of pigment interacting with the binding agent, in the method according to the invention, a homogeneous distribution is already produced just by mechanical convection, in particular, with the use of a stirrer.

An axially-conveying stirrer is preferably used for this purpose. This is particularly advantageous, since in the case of axially-conveying stirrers, in comparison to radially-conveying stirrers, small shearing forces occur. In one embodiment, a bladed or propeller stirrer, preferably a 3-bladed or 4-bladed propeller stirrer is used. It has also been demonstrated as particularly advantageous to draw-in the material to be mixed axially, for example, from top to bottom. An axial flow is produced thereby in the vessel, whereby the locally occurring shearing forces are minimal. Thus, deformation or damage of the electrically conductive particles does not occur or only occurs to a very small extent in the case of the method according to the invention.

In particular, a stirrer with a rotational speed of up to 3000 rpm, preferably with a rotational speed in the range of 100 to 2000 rpm, and more preferably with a rotational speed in the range of 300 to 1500 rpm is used.

Due to the relatively small shearing forces, unlike those that occur, for example, with the use of a ball mill or a roll mill described in the prior art, it is assured that the pigments utilized are not deformed or damaged in another way.

Although the fraction of electrically conductive pigment in the coating compound is thus comparatively very small, the coating nevertheless has a good electrical conductivity. This can be particularly attributed to the fact that, due to the careful homogenizing method according to the invention for the dispersion of the pigments in the binding agent, the shape of the pigment particles utilized is maintained, and the pigment particles, for example, are not deformed. At the same time, the small fraction of electrically conductive pigment first makes possible the use of small shearing forces, so that a synergistic effect prevails between the maximally applied shearing force or the applied homogenizing method and the small fraction of pigment.

This synergistic effect in this case is particularly strongly developed with the use of flake-shaped graphite particles as the electrically conductive pigment. Due to the homogenization with small shearing forces in producing the dispersion, unlike in conventional homogenizing methods, defects in the electrically conductive pigments, for example, in the graphite flakes due to a breaking off of partial regions of the flakes, do not occur or occur only to a very small extent.

In a subsequent method step, the thus-obtained coating compound is printed onto a substrate, preferably a substrate comprising glass or glass ceramics, structured partially, i.e., not over the entire surface.

The printing method can be a screen-printing method, an ink-jet printing method, an offset-printing method, a pad-printing method, a roll-coating method, a dipping method, a spin-coating method, or a spraying method. The coating material is preferably applied onto the substrate by means of the screen-printing method.

In general, heat-resistant materials, such as metals, alloys, appropriate plastics, glass, glass ceramics or ceramics can be used as the substrate. The substrate is preferably a glass ceramic. In this case, the glass ceramic may be coated. In particular, the glass ceramic may have a decorative layer and/or a silicone-based sealing layer.

Special glass substrates are preferred as the substrate. Such special glass substrates may be glass ceramics, in particular, transparent, colored lithium aluminosilicate (LAS) glass ceramics, transparent LAS glass ceramics, or magnesium aluminosilicate glass ceramics, or lithium disilicate glass ceramics, or silicate glasses, for example, borosilicate glasses, zinc borosilicate glasses, boroaluminosilicate glasses, aluminosilicate glasses, alkali-free glasses, soda-lime glasses, or a composite material formed from the above-named glasses and/or glass ceramics.

A heat-shock-resistant special glass or a glass ceramic having a thermal expansion coefficient of less than 4.0·10⁻⁶/K, preferably less than 3.4·10⁻⁶/K, is preferably used. A borosilicate glass or a lithium aluminosilicate glass ceramic with a high-quartz mixed-crystal phase or keatite is preferably used. The crystal-phase content in this case lies between 60 and 85%.

In a particular embodiment, a pre-stressed special glass substrate is used, in particular, boroaluminosilicate glasses (for example, SCHOTT Xensation™, Corning Gorilla™ I-III, Asahi Dragontrail™). In this case, the pre-stressing can be induced chemically or thermally. The substrate here can be rigid or flexible. The substrate can be planar or bent or deformed in this case.

Substrates that are smooth on both sides or also knobby on one side may be used, whereby knobby substrates with a leveling layer (e.g., of polyurethane or silicones or silicone resins) may be provided, which fulfill the use properties. The substrate may have mechanically processed or also etched surfaces.

In the case of special glass substrates composed of transparent colored glass ceramics, the light transmittance of the substrate in the visible range (light transmittance according to ISO 9050:2003, 380-780 nm) for a substrate thickness of 4 mm is 0.8-10%. The transmittance of the special glass substrate is ≧45% in the infrared in the range of 850 nm to 970 nm.

According to one embodiment, a lithium-aluminum silicate (LAS) glass ceramic with high-quartz mixed crystals (HQMK) and/or keatite mixed crystals (KMK) as the prevalent crystal phase is used. Preferably, LAS glass ceramics containing TiO₂, ZrO₂ and/or SnO₂ are used as nucleating agents.

Preferably, the glass ceramics used have a crystal phase content of 50 to 85%, preferably of 60 to 80%, and even more preferably of 64 to 77%.

Substrate glasses are preferably used such as those employed in the field of white goods or household appliances, for example, for baking and cooking appliances, microwave ovens, refrigerators, steam cookers, control panels for such appliances, gas cooking appliances, rinsing appliances or dishwashers. Substrate glasses such as those employed for cooktops, oven panels or fireplace viewing panels are more preferably used.

In an advantageous configuration of this embodiment, the substrates comprise less than 1000 ppm, preferably less than 500 ppm, and even more preferably less than 200 ppm of arsenic and/or antimony. According to one embodiment, the glass ceramics used are free of arsenic and antimony. In particular, the glass ceramics involve transparent glass ceramics.

The conductive coating can be structured laterally (for example in the nm, μm, mm, or cm range) on the substrate in one or more partial regions, or it can be applied over the entire surface. Such a structuring makes possible, for example, the creation of single-touch sensor electrodes or structured fields of single-touch sensor electrodes in the cold region of a cooktop. An application of the conductive coating over the entire surface, but preferably in a partial region of the substrate, makes it possible to provide, for example, a touch field (touch screen) with spatial resolution, in which, by way of example, the spatial resolution is obtained by evaluating the difference signals at the corners.

In a preferred embodiment, a transparent substrate having one or more decorative coatings, such as, for example, colored or transparent decorations, is used, wherein colored decorations may be pigmented. In another preferred embodiment, a transparent substrate provided with one or more functional coatings is used. These decorative and/or functional coatings in this case may be found on the same side as the conductive coating or on the opposite side. The additional coatings may be applied either over the entire surface or as structured, such as, for example, as cooking-zone markings or with a recess for a display.

Further, several layers of the conductive coating can be applied on the substrate. In a particular embodiment, a dielectric layer and/or a layer acting as an anti-reflection layer is (are) found between several conductive layers. For example, the anti-reflection layer may be composed of silicon oxide and/or silicon nitride. Such a layer construction makes it possible, for example, to create spatially-resolved capacitive multi-touch sensors.

After applying the coating compound or the preparation, the thus-obtained coating is dried at temperatures in the range of 20 to 250° C. The solvent is largely removed from the binding agent in this way. Also, another crosslinking of the binding-agent matrix takes place, so that the coatings have a high strength even after just the drying step.

Surprisingly, the coatings that were produced by the method according to the invention are characterized by a high electrical conductivity even just after drying. Distinct from this, a comparable electrical conductivity is first obtained with known methods by high burning-in temperatures.

In an enhancement of the invention, in fact, a temperature treatment can be completely omitted in the drying process. Also, the coatings according to the invention have a high scratch resistance even with low drying or burning-in temperatures.

Therefore, it is possible to obtain an electrically conductive coating without the need for burning-in the coating at high temperatures to do so. The coating can be dried at temperatures of <200° C. or, in fact, at room temperature. This is advantageous if the substrate already has one or more coatings, for example, decorative or sealing layers that do not permit high burning-in temperatures due to their lower temperature resistance. Therefore, due to the low temperatures, even already pre-coated substrates, for example, substrates with sol-gel-based or silicone-based layers as decorative or sealing layers, which would be disrupted at high temperatures, can additionally be provided with an electrically conductive coating.

A high electrical conductivity with low drying temperatures or without a drying step is particularly favored here by the use of flake-shaped graphite particles as the electrically conductive pigment, since the parallel arrangement of the flake-shaped pigment particles advantageously acts on the electrical conductivity and for this reason, an annealing step is not required.

The electrically conductive coating according to the invention itself has a high temperature resistance, so that a burning-in at temperatures of up to 500° C. is also possible. In an enhancement of the invention, the coating is thus burned-in at temperatures in the range of 200 to 500° C. after the drying step. The electrical conductivity of the coating can be increased still further thereby. This is then particularly advantageous if the substrate has no other coating or at least no other temperature-sensitive coating in addition to the electrically conductive layer. The adherence of the electrically conductive layer on the substrate is also improved by the burning-in step, so that the layer will be more scratch-resistant. The coating is particularly suitable for use on cooktops due to the high scratch resistance of the electrically conductive coating in combination with the high temperature resistance.

In addition, the present invention relates to a corresponding preparation, i.e., a coating compound, for coating a substrate with an electrically conductive layer.

The preparation comprises a binding agent with a binding-agent matrix containing SiO₂ and a solvent. The binding-agent matrix has a network formed by silicon-oxygen bonds and is inorganically crosslinked. In addition, the preparation contains carbon dispersed in the binding agent, particularly in the form of flake-shaped graphite, as the electrically conductive pigment. The fraction of electrically conductive pigment in the preparation amounts to 10 to 40 wt. %.

According to one embodiment, the preparation has a fraction of electrically conductive pigment of from 10 to 35 wt. %, preferably from 12 to 30 wt. %.

The solvent is selected so that the preparation is printable without needing to additionally add an agent for controlling the rheology. In particular, the preparation is suitable for use as a printing paste in the screen-printing method.

According to one embodiment, the viscosity of the preparation (measured with a rotational speed of 140 l/min) is 1 to 20,000 cP, preferably 10 to 10,000 cP, and more preferably 100 to 5000 cP. The viscosities were measured with a rotary viscometer with ball-plate geometry, whereby a torsional shear deformation was applied, i.e., the sample was deformed between ball and plate, and a defined shearing resulted. The holding time for each rotational speed was 20 seconds.

In one variant of the invention, the binding-agent matrix involves a sol-gel network.

In an embodiment, it involves a purely inorganically crosslinked sol-gel network with no organic groups or only a few organic groups. The organic groups in this embodiment can be attributed to an incomplete hydrolysis of a tetraalkoxysilane. In addition to a good adherence onto glass and glass-ceramic substrates, these predominantly inorganic sol-gel binding agents have a high temperature resistance.

The binding-agent matrix, however, can also contain organic residues or groups that are covalently bonded to the sol-gel network. The sol-gel binding agent can also have an inorganic-organic hybrid network.

An inorganic degree of crosslinking of 40 to 90%, particularly of 50 to 80%, and more particularly of 60 to 80% has been demonstrated as particularly advantageous.

In one embodiment of the invention, the preparation contains a solvent with a vapor pressure of <5 bars, a boiling point of >120° C., and/or an evaporation number of >10. In particular, the solvent has a vapor pressure of <1 bar, and preferably <0.1 bar; a boiling point of >150° C., and preferably >200° C.; and/or an evaporation number of >500 and preferably >1000.

A glycol, a glycol ether, a terpineol, and/or a polyol can be used, in particular, as the solvent. The solvent is more preferably selected from the group formed by n-butyl acetate, methoxybutyl acetate, butyl diglycol, butyl diglycol acetate, cyclohexanone, diacetone alcohol, diethylene glycol, dipropylene glycol monomethyl ether, dipropylene glycol monobutyl ether, dipropylene glycol monopropyl ether, propylene glycol monobutyl ether, propylene glycol monopropyl ether, propylene glycol monoethyl ether, ethoxypropyl acetate, hexanol, methoxypropyl acetate, monoethylene glycol, ethyl pyrrolidone, propylene glycol, propylene glycol monomethyl ether, mixtures of paraffinic and naphthenic hydrocarbons, aromatic hydrocarbon mixtures, mixtures of aromatic, alkylated hydrocarbons, mixtures of n-, i-, and cyclo-aliphates, and terpineol. The use of solvent mixtures is also possible.

According to another embodiment of the invention, the preparation contains a silicone resin, in particular, an alkyl-modified and/or an aryl-modified silicone resin as the binding-agent matrix. The use of methyl-modified and/or phenyl-modified silicone resins has been demonstrated as particularly advantageous with respect to the temperature resistance and flexibility of a coating that can be produced by means of the preparation. The silicone resins may also have another modification, for example, by epoxy or polyester groups.

In an enhancement of the invention, the preparation additionally contains additives and adjuvants, such as leveling agents, defoamers, deaerators, thickeners, hardeners or curing agents, initiators, corrosion inhibitors, adhesion promoters, surface reactants (surfactants) and/or dispersing additives. “Dispersing additives” are understood here to be, in particular, those additives that lead to a better pigment wetting and thus prevent a settling of the pigments, without significantly changing the rheology of the preparation. The additives and adjuvants act positively on the homogeneity of the pigment distribution.

In one embodiment of the invention, mineral-oil-based defoamers, silicone-free defoamers, and/or defoamers based on silicone, for example, organically modified siloxanes, in particular, siloxane copolymers or polydimethylsiloxanes are used as defoamers.

The preparation is particularly suitable for use as a printing paste for coating a substrate by means of a printing method. The preparation is particularly suited for use as a printing paste in a screen-printing method.

In addition, the invention relates to a substrate having an electrically conductive coating, in particular, one that can be produced by the above-described method. The electrically conductive coating comprises an inorganically crosslinked SiO₂-containing matrix. Due to a high degree of crosslinking of the matrix, the layer has a high temperature resistance as well as a good scratch resistance.

Flake-shaped graphite particles are dispersed in the matrix as electrically conductive pigments. Preferably, the fraction of electrically conductive pigment particles in the coating compound used for producing the coating amounts to 10 to 35 wt. %, that is, prior to the drying of the coating compound.

In one embodiment of the invention, no electrically conductive pigments other than the flake-shaped graphite particles are contained in the coating.

In the sense of the invention, an “SiO₂-containing matrix” is particularly understood to be a matrix whose network is formed by silicon-oxygen bonds. The matrix may be purely inorganic or it may have organic residues or groups that are bound to silicon atoms of the network.

One embodiment of the invention provides that the matrix involves a sol-gel matrix or a sol-gel network. Temperature-resistant and scratch-resistant coatings can be particularly obtained in this case, if the sol-gel matrix has an inorganic degree of crosslinking of 40 to 90%, preferably 50 to 80%, and more preferably 60 to 80%.

In another embodiment, the coating contains a silicone resin as the matrix, in particular, an alkyl-modified or aryl-modified silicone resin. Methyl-modified or phenyl-modified silicone resins have been demonstrated as particularly advantageous here. Alternatively or additionally, the silicone resins are epoxy-modified and/or polyester-modified, i.e., they have epoxy or polyester groups that, for example, enable an additional organic crosslinking of the matrix via crosslinking of the organic groups.

The coated substrate or the coating according to the invention has a good electrical conductivity, based on the spatial arrangement of the graphite flakes in the matrix, i.e., predominantly relative to the alignment of the surfaces of the graphite flakes in the direction of the substrate surface, despite the relatively small fraction of electrically conductive pigment. In particular, the coated substrate according to the invention has a surface resistance of 5 to 1000 Ohms/square, preferably 10 to 500 Ohms/square, more preferably 20 to 200 Ohms/square.

According to one embodiment of the invention, the coating (after drying) has a fraction of electrically conductive pigment of 20 to 80 wt. %, preferably of 30 to 70 wt. %, more preferably of 40 to 60 wt. %. In this case, the electrical conductivity of the coating can be still further increased by increasing the graphite fraction.

In addition, the electrical conductivity of the coating can also be adjusted via its layer thickness. The layer thickness of the coating preferably amounts to 5 to 25 micrometers, more preferably 5 to 20 micrometers, and even more preferably 5 to 15 micrometers. In this case, due to a relatively thick layer, for example, a high electrical conductivity of a coating can be achieved, which (within the scope of the invention) has a relatively low fraction of conductive pigment.

Another parameter for influencing the electrical conductivity of the coating consists in the size of the electrically conductive graphite particles that are used. With increasing size, the electrical conductivity of the coating also increases; however, the use of particles that are too large has been demonstrated as disadvantageous in production, in particular, in the homogenizing of the graphite flakes and SiO₂-containing matrix.

In an advantageous configuration, the electrically conductive pigment involves flake-shaped graphite particles with a size d90 in the range of 1 to 100 μm, preferably in the range of 2 to 50 μm, and more preferably in the range of 3 to 25 μm. A high electrical conductivity of the coating can be obtained via these sizes. At the same time, the graphite flakes are still small enough that a homogeneous distribution in the matrix is assured. An enhancement provides that the coating contains at least two fractions of flake-shaped graphite particles of different d90 sizes.

The coating is permanently stable vis-à-vis temperatures of at least 300° C., more preferably vis-à-vis temperatures of up to 500° C. The stability vis-à-vis a constant temperature loading with maximum temperatures of up to 500° C., particularly also in combination with a high scratch resistance of the coating, makes possible, for example, the use of the coated substrate as a cooktop.

In another configuration, the coating has a scratch resistance of 500 to 1000 g. An enhancement of the invention also provides that the coating additionally contains inorganic nanoparticles. The scratch resistance of the coating can be increased still further thereby. At the same time, however, the resistance of the coating increases, since the nanoparticles influence the arrangement of the graphite flakes in the matrix. Therefore, the addition of nanoparticles is then particularly advantageous if a high scratch resistance of the coating is important, in addition to the conductivity, for example, in the case of coated substrates that are subjected to high mechanical stresses.

By selection of the nanoparticles, the coating in this case can be optimally adapted to the respective requirements. Thus, spherical nanoparticles, irregularly shaped nanoparticles, for example, in colloidal form of aqueous dispersions or flame-pyrolytically produced nanoparticles, can be contained therein. The nanoparticles can be produced via milling processes, aerosol methods, such as, e.g., flame hydrolysis, spray pyrolysis, precipitation reactions, sol-gel reactions, Stöber processes, plasma methods, or hydrothermal processes.

An embodiment of the invention provides that nanoparticles made of oxidic materials are used in the coating, such as TiO₂ (anatase and/or rutile), ZrO₂ (amorphous, monoclinic and/or tetragonal phase), Ca or Y₂O₃-doped ZrO₂, MgO-doped ZrO₂, CeO₂, Gd₂O₃-doped CeO₂, Y-doped ZrO₂, SiO₂, B₂O₃, Al₂O₃ (α, γ, or amorphous shape), SnO₂, ZnO, Bi₂O₃, Li₂O, K₂O, SrO, NaO, CaO, BaO, La₂O₃ and/or HfO₂, boehmite, andalusite, mullite, and their mixed oxides. SiO₂-containing nanoparticles are preferably used.

The substrate involves a heat-resistant material, particularly glass, glass ceramics, metal, alloys, or a corresponding heat-resistant plastic. The substrate is preferably a glass ceramic. In this case, the substrate may be coated. In one embodiment, in addition to the electrically conductive coating, the substrate has at least one other coating. According to one embodiment, additional layers are disposed between the substrate surface and the electrically conducting coating. These layers preferably comprise decorative and/or sealing layers. Several layers can also be applied on the upper side and/or under side of the substrate in addition to the electrically conductive coating. In particular, the substrate can have decorative and/or silicone-based sealing layers.

According to one embodiment, a lithium-aluminum silicate (LAS) glass ceramic with high-quartz mixed crystals (HQMK) and/or keatite mixed crystals (KMK) as the prevalent crystal phase is used. Preferably, LAS glass ceramics containing TiO₂, ZrO₂ and/or SnO₂ are used as nucleating agents. Preferably, the glass ceramics used have a crystal-phase content of 50 to 85%, preferably of 60 to 80%, and even more preferably of 64 to 77%.

In an advantageous configuration of this embodiment, the substrates comprise less than 1000 ppm, preferably less than 500 ppm, and even more preferably less than 200 ppm of arsenic and/or antimony. According to one configuration, the glass ceramics used are free of arsenic and antimony.

In particular, the glass ceramics involve transparent glass ceramics.

The electrically conductive coated substrate can be used as a cooktop, in particular, if the substrate is a glass ceramic. The electrically conducting coating in this case can be applied both in the cold region of the cooktop, for example, in the display region, as well as in the hot region, i.e., in the cooking-zone region.

In particular, the electrically coated substrate can be used as a touch sensor, an overflow sensor, an electrical field for screening, or as part of an illumination means.

The present invention will be described in more detail below on the basis of figures as well as on the basis of embodiment examples.

### BRIEF DESCRIPTION OF THE DRAWINGS

The patent or application file contains at least one photograph. Copies of this patent or patent application publication with photograph(s) will be provided by the Office upon request and payment of the necessary fee.

FIG. 1 shows a schematic representation of an example of embodiment of the production method according to the invention, in which a sol-gel binding agent is provided;

FIG. 2 shows a schematic representation of an embodiment of a coated substrate according to the invention;

FIG. 3 shows a schematic representation of another embodiment of a coated substrate according to the invention, wherein the coating additionally contains nanoparticles;

FIG. 4 shows a schematic representation of a third embodiment of a coated substrate according to the invention, wherein a decorative layer and a sealing layer are disposed between the substrate and the electrically conductive coating;

FIG. 5 shows the DSC and TG curves of two embodiment examples of the electrically conductive coating according to the invention;

FIG. 6 shows the layer thicknesses of different embodiment examples of the electrically conductive coating according to the invention as a function of the graphite fraction in the coating as well as the burning-in temperature;

FIG. 7 shows the surface resistance of the electrically conductive coating of different embodiment examples of the electrically conductive coating according to the invention as a function of the graphite fraction in the coating as well as the burning-in temperature;

FIGS. 8a to 8c show the resistance of different embodiment examples of the electrically conductive coating according to the invention according to the scratch test as a function of the burning-in temperature and the weight used;

FIG. 9 shows a light micrograph of an electrically conductive coating according to the invention on the surface of a glass-ceramic substrate after a scratch test; and

FIG. 10 shows a light micrograph of an electrically conductive coating according to the invention on a layer composite made of a sol-gel-based layer and a sealing layer after a scratch test.

### DETAILED DESCRIPTION

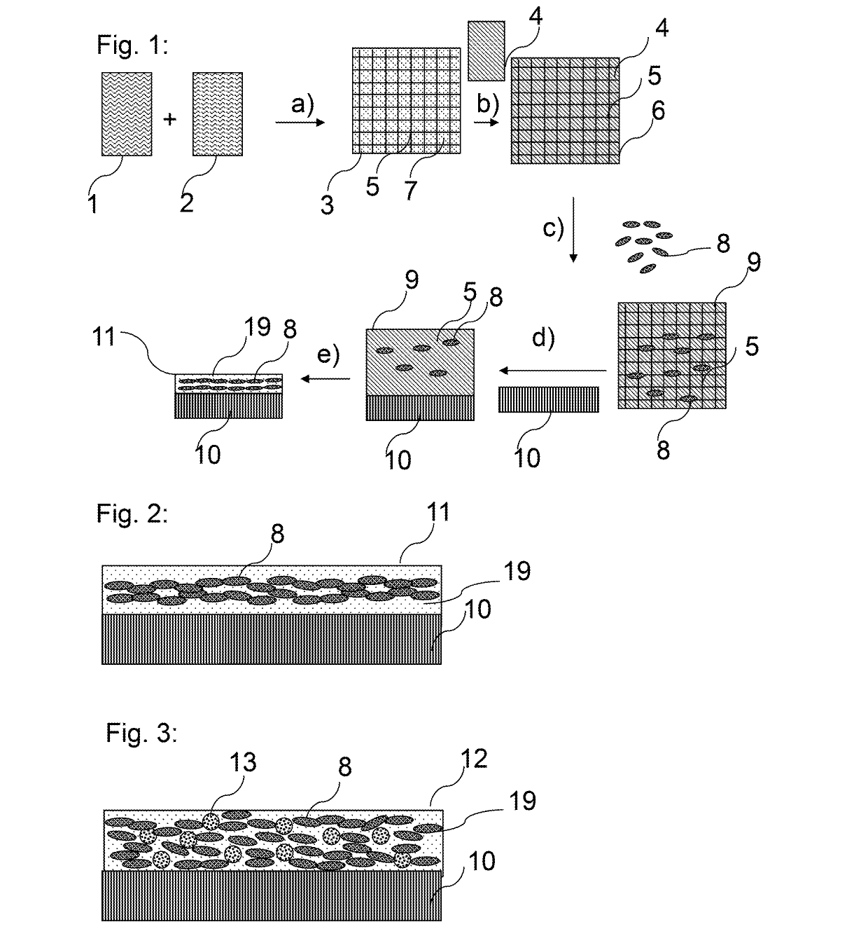

FIG. 1 shows schematically an embodiment of the production method, in which first a sol-gel binding agent is produced by hydrolysis. In step a), a monomer 1 is combined with an aqueous solution 2. In this way, the hydrolysate 3 is formed with an inorganically crosslinked sol 5 as the binding-agent matrix as well as a low-boiling alcohol as a liquid condensation product 7.

A solvent exchange is produced in step b). For this purpose, the hydrolysate 3 is mixed with a solvent 4. The solvent 4 in this case has a higher boiling point than the liquid condensation product 7, so that the condensation product 7 can be removed, for example, by distillation (not shown).

Now in step c), flake-shaped graphite particles 8 are dispersed as an electrically conductive pigment in the solvent-exchanged hydrolysate, i.e., the binding agent 6 with the solvent 4. In order to assure a homogeneous distribution of the graphite particles 8, they are added to the binding agent 6 while stirring, so that the coating compound 9 is obtained. The coating compound 9 contains the inorganically crosslinked sol 5 as well as the flake-shaped graphite particles 8 that are distributed homogeneously therein as the electrically conductive pigment. In addition, the coating compound 9 contains the solvent 4. In step d), the coating compound can be applied onto a substrate 10 in this way, for example, by means of a printing process, in particular, by screen printing. In this case, the application of the coating compound 9 onto the substrate 10 is produced so that it is laterally structured, i.e., not over the entire surface (not shown).

The substrate 10 provided with coating compound 9 is then dried (step e)). The solvent 4 is removed thereby and the electrically conductive coating 11 is formed. The flake-shaped graphite particles are embedded in a sol-gel matrix 19 in this way. During the drying process, another crosslinking of the sol-gel matrix 5 results, so that the sol-gel matrix 19 of the dried coating has a higher degree of crosslinking than the sol-gel matrix of the coating compound 9.

FIG. 2 shows schematically an excerpt from the substrate 10 provided with the electrically conductive coating 11. The inorganically crosslinked sol-gel 19 serves as a matrix for the flake-shaped graphite particles 8, which are distributed homogeneously in the matrix 19.

FIG. 3 shows schematically an excerpt from another embodiment of the invention. The electrically conductive coating 12 introduced onto the substrate 10 has inorganic nanoparticles 13 in the matrix, in addition to the electrically conductive pigments. These nanoparticles lead to an increase in the scratch resistance of the coating 12.

FIG. 4 shows schematically an enhancement of the coated substrate 10 according to the invention. Here, the electrically conductive coating 11 is not applied directly onto the surface of the substrate 10, but rather a layer composite 16, composed of a sol-gel-based decorative layer 15 and a silicone-based sealing layer 14 is found between substrate 10 and the electrically conductive coating 11. The electrically conductive coating 11 in this embodiment is disposed on the sealing layer 14.

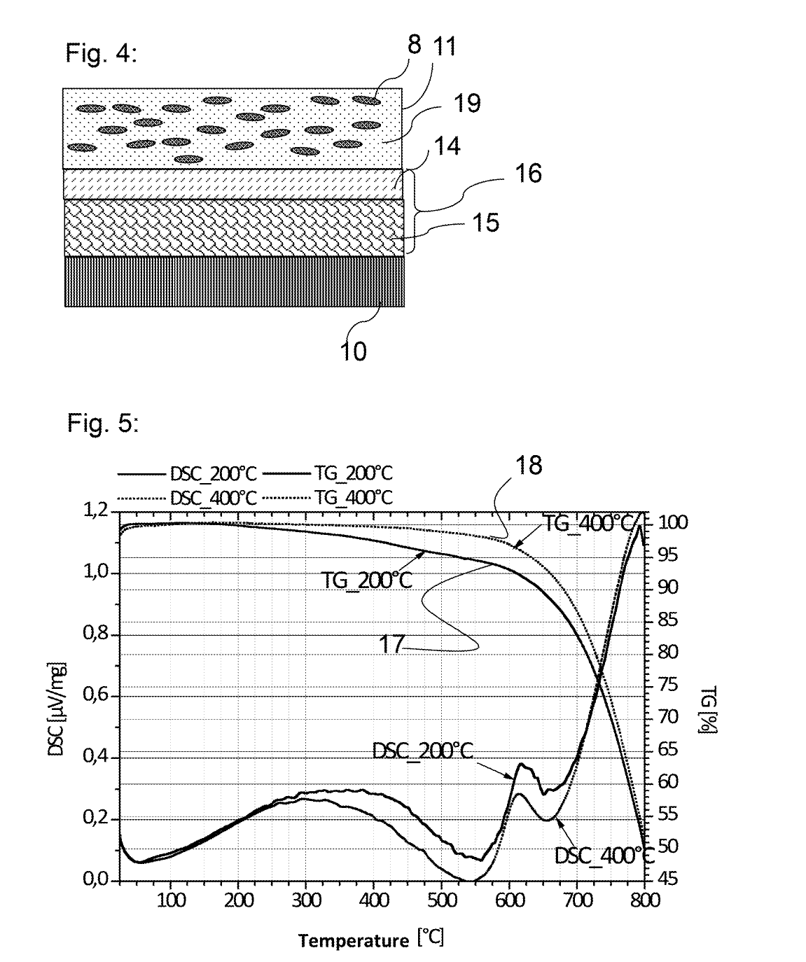

FIG. 5 shows the DSG and TG curves of two coated substrates 17 and 18. The coated substrates 17 and 18 are distinguished in that, in the production of the coated substrate 18, after the electrically conducting coating 11 was dried, it was additionally burned-in at a temperature of 400° C.

Both coated substrates 17 and 18 in this case show a high resistance to temperature loads of at least 500° C. Starting from temperatures of 550° C., the course of the two TG curves indicates a clear decrease in mass. In both cases, this can be attributed to the fact that a decomposition of the organic residues of the binding agent takes place starting from approximately 550° C.

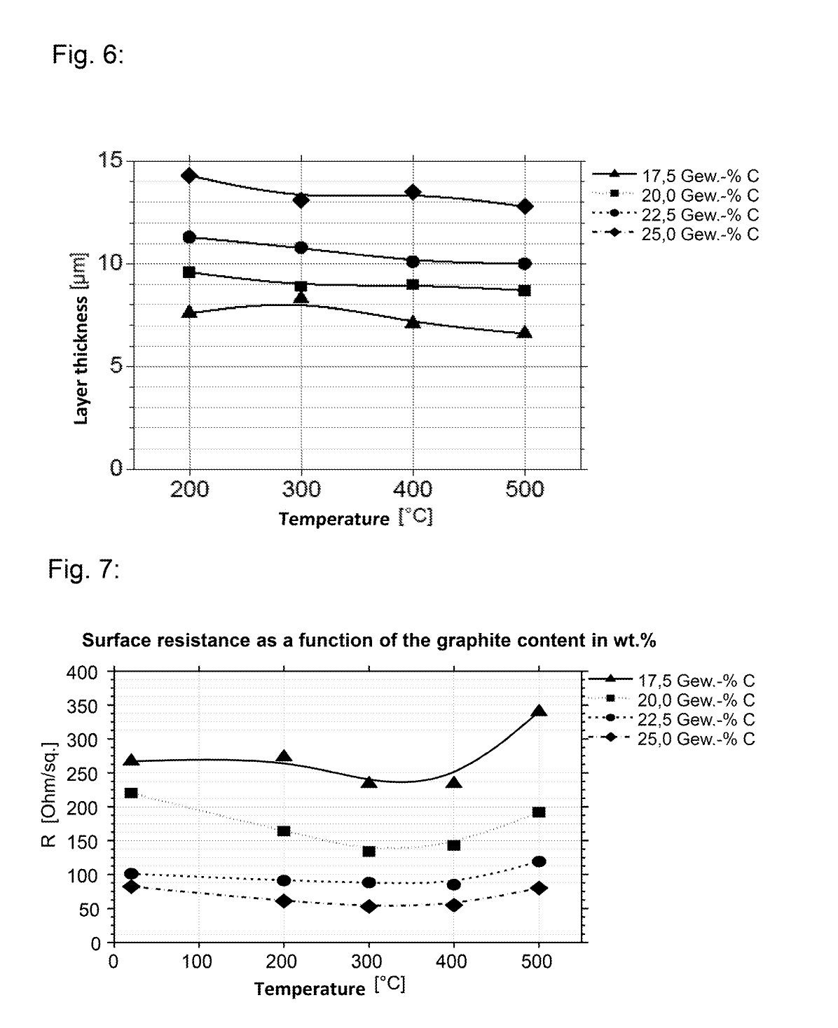

FIG. 6 shows the layer thicknesses of the electrically conductive coating as a function of the respective graphite content (relative to the coating compound prior to drying) and as a function of the burning-in temperature. The layer thicknesses were determined with a tactile profilometer with diamond needle. Independent of the graphite content, the layer thickness decreases with increasing burning-in temperature, i.e., the coating becomes increasingly compacted with increasing burning-in temperature.

FIG. 7 shows the surface resistance of the electrically conductive coating as a function of the respective graphite content (relative to the coating compound prior to drying) and as a function of the burning-in temperature.

The surface resistance of the electrically conductive coating was determined with a 4-point measuring instrument MR-1 of the company Schuetz Messtechnik. First, the resistance R of a complete surface layer having a surface area of 22*28 cm² was measured thereby, assuming the form factor XL. Subsequently, this value was multiplied by the factor π/ln² and thus the surface resistance in [Ω/square] was obtained.

The surface resistance in this case is dependent both on the graphite fraction as well as also on the burning-in temperature. Thus, a large graphite fraction and therefore a large fraction of electrically conductive material in the coating results in a high electrical conductivity and thus a low surface resistance. In addition, the surface resistance decreases within the indicated burning-in temperatures of 200° C. to 400° C., since the layer is compacted due to the burning-in. With a burning-in temperature of 500° C., however, the surface resistance increases. This can be explained by the increasing formation of microcracks in the coating at high temperatures.

Therefore, with the graphite content and the burning-in temperature, two parameters that are independent of one another are available for adjusting the desired surface resistance or the desired electrical conductivity.

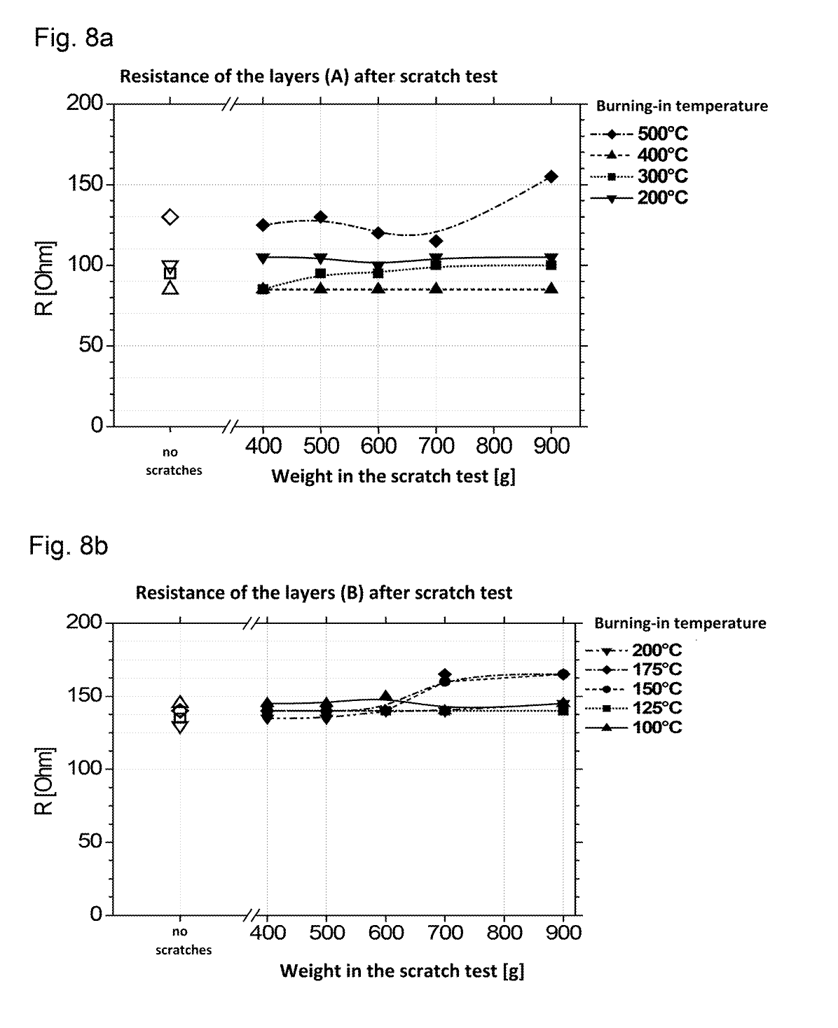

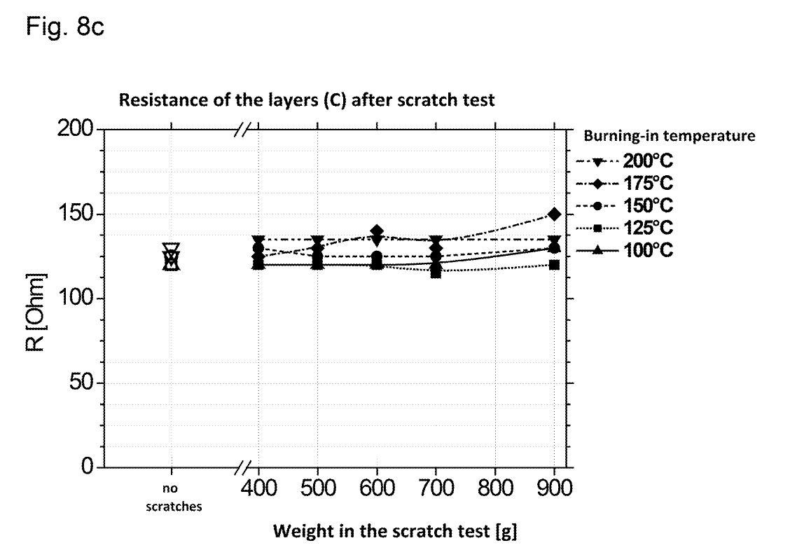

FIGS. 8a to 8c show the electrical resistance of different embodiment examples A to C, in which the coating has a sol-gel matrix, according to the scratch test as a measurement for the scratch resistance as a function of the weight used in the test and as a function of the drying or burning-in temperature of the respective electrically conductive coating.

The embodiment examples A to C are distinguished by the monomers used for the sol-gel binding agent and by the solvent used or by the solvent content.

Thus, in embodiment example A, tetraethoxysilane (TEOS) is used as the monomer, which leads to a purely inorganically crosslinked sol-gel network with a very small fraction of organic groups, whereas the hydrolysate in embodiment examples B and C has an inorganic-organic hybrid network due to the use of methyltriethoxysilane (MTEOS).

The scratch resistance was determined by a Scratch Hardness Tester 413 of the Erichsen company. A tungsten carbide tip with a diameter of 1 mm was used as the measurement tip. The scratch resistance of the coating was in the range of 500 to 1000 g, i.e., 5 to 10 N.

The scratch resistance in this case is defined as follows according to the invention: If the electrical conductivity of the conductive coating to be tested is not adversely affected by the scratch test or the scraping action carried out with the corresponding weight, then the coating is considered scratch-resistant with respect to this weight. The resistance of the conductive coating after carrying out the scratch test was measured with a multimeter at a distance between the two measuring tips of 0.5 cm.

The layers of all embodiment examples A to C show a high scratch resistance even with just low burning-in temperatures. This resistance can be increased further by higher burning-in temperatures of up to 400° C. due to the resulting compacting, whereas a burning-in temperature of 500° C. has as a consequence a lower scratch resistance. An explanation for this might lie in the increasing formation of microcracks.

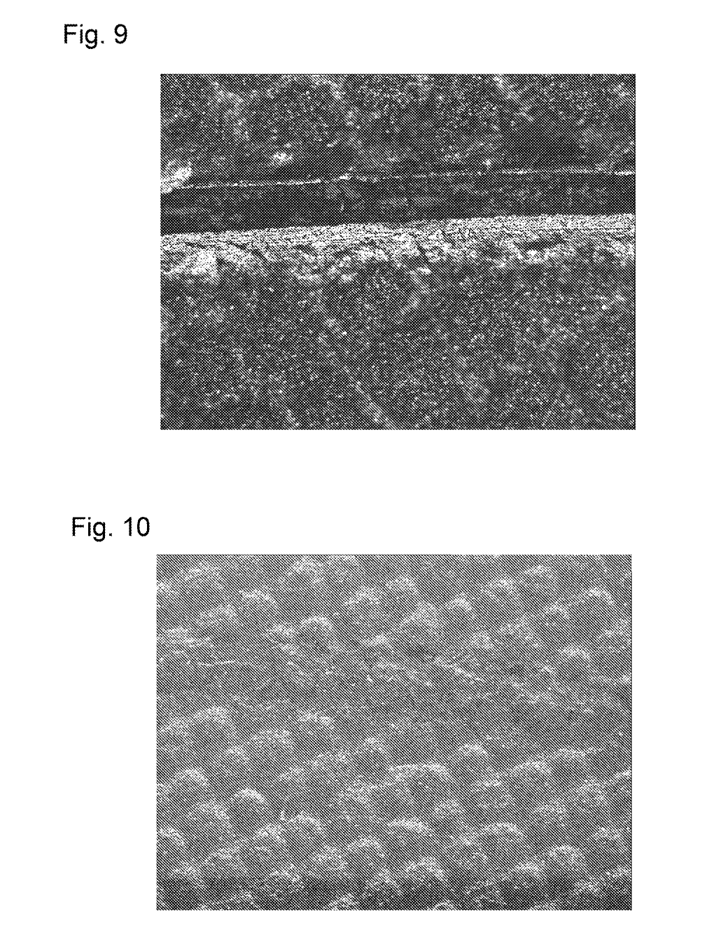

FIG. 9 shows light micrographs of a conductive coating on a) a glass-ceramic surface and b) on a layer composite made of a sol-gel-based layer and a sealing layer, in each case after conducting the scratch test with a weight of 900 g. It is shown surprisingly that the scratch resistance of the electrically conductive coating, which was printed on the layer composite (see also FIG. 4) is clearly higher than the scratch resistance of an electrically conductive coating that was printed directly on the glass-ceramic surface (see also FIG. 2). This can be explained in particular by the knobby-like surface structure of the coating with “hills” and “valleys” in FIG. 10). The knobby-like structure in this case can be attributed to the screen used in the screen printing. Due to this structure, it is predominantly the “hills” of the coating that are damaged in the scratch test, whereas the “valleys”, on the other hand, remain intact.

A sol-gel binding agent was used in the case of embodiment examples A to E; a binding agent having a silicone-resin binding-agent matrix was used for embodiment examples F and G.

### Example a

### Step a) Preparation of the Coating Material

0.24 mole of p-toluenesulfonic acid is dissolved in 6.48 moles of tetraethoxysilane (TEOS) and the mixture is reacted with 9.07 moles of water.

After the sol-gel reaction has terminated, 208 g of terpineol are added to 300 g of the hydrolysate. Subsequently, the low-boiling solvent that has formed during the sol-gel reaction is removed on the rotary evaporator.

25 g of graphite are dispersed in 75 g of binding agent. Additionally, 0.2 to 0.5 g of defoamer, for example, a silicone oil can be added.

First, the liquid phase is weighed-in; then the flake-shaped graphite particles are added as a solid phase. The graphite particles are dispersed in the binding agent by means of a propeller stirrer at a rotational speed of 300 to 1500 rpm. Here, the material to be mixed is drawn-in from top to bottom and an axial flow is produced.

### Step b) Production of the Electrically Conductive Coating

The coating material produced in a) is printed on the substrate in a partially structured manner by means of screen printing. Subsequently, the coated substrate is dried for 90 minutes at a temperature of 200° C. and burned-in for 90 minutes at temperatures between 300 and 500° C.

### Example B

### Step a) Preparation of the Coating Material

0.13 mole of p-toluenesulfonic acid is dissolved in 3.37 moles of methyltriethoxysilane (MTEOS). Subsequently, 0.84 mole of tetraethoxysilane (TEOS) is added and the mixture is reacted with 4.71 moles of water.

After the sol-gel reaction has terminated, 132 g of terpineol and 33.0 g of n-butyl acetate are added to 300 g of the hydrolysate. Subsequently, the low-boiling solvent that has formed during the sol-gel reaction is removed on the rotary evaporator.

25 g of graphite are dispersed in 75 g of binding agent. Additionally, 0.2 to 0.5 g of defoamer, for example, a silicone oil can be added.

First, the liquid phase is weighed in; then the flake-shaped graphite particles are added as a solid phase. The graphite particles are dispersed in the binding agent by means of a propeller stirrer at a rotational speed of 300 to 1500 rpm. Here, the material to be mixed is drawn-in from top to bottom and an axial flow is produced.

### Step b) Production of the Electrically Conductive Coating

The coating material produced in a) is printed on the substrate in a partially structured manner by means of screen printing. Subsequently, the coated substrate is dried for 90 minutes at a temperature of 100° C. to 200° C. An additional burning-in of the layers is not necessary.

### Example C

### Step a) Preparation of the Coating Material

0.13 mole of p-toluenesulfonic acid is dissolved in 3.37 moles of methyltriethoxysilane (MTEOS). Subsequently, 0.84 mole of tetraethoxysilane (TEOS) is added and the mixture is reacted with 4.71 moles of water.

After the sol-gel reaction has terminated, 210 g of terpineol and 42.1 g of n-butyl acetate are added to 300 g of the hydrolysate. Subsequently, the low-boiling solvent that has formed during the sol-gel reaction is removed on the rotary evaporator.

25 g of graphite are dispersed in 75 g of binding agent. Additionally, 0.2 to 0.5 g of defoamer, for example, a silicone oil can be added.

First, the liquid phase is weighed-in; then the flake-shaped graphite particles are added as a solid phase. The graphite particles are dispersed in the binding agent by means of a propeller stirrer at a rotational speed of 300 to 1500 rpm. Here, the material to be mixed is drawn-in from top to bottom and an axial flow is produced.

### Step b) Production of the Electrically Conductive Coating

The coating material produced in a) is printed on the substrate in a partially structured manner by means of screen printing. Subsequently, the coated substrate is dried for 90 minutes at a temperature of 100° C. to 200° C., An additional burning-in of the layers is not necessary.

### Example D

### Production of a Substrate with an Electrically Conductive Coating (Inorganic-Organic Binding Agent)

Step a) Preparation of the Coating Material

0.07 mole of p-toluenesulfonic acid is dissolved in 2.13 moles of methyltriethoxysilane (MTEOS). Subsequently, 0.53 mole of tetraethoxysilane (TEOS) is added and the mixture is reacted with 2.56 moles of water. After the sol-gel reaction has begun, the mixture is heated to a temperature of >50° C.

After the sol-gel reaction has terminated, 189 g of terpineol and 47.3 g of n-butyl acetate are added to 300 g of the hydrolysate. Subsequently, the low-boiling solvent that has formed during the sol-gel reaction is removed on the rotary evaporator.

25 g of graphite are dispersed in 75 g of binding agent. Additionally, 0.2 to 0.5 g of defoamer, for example, a silicone oil can be added.

First, the liquid phase is weighed-in; then the flake-shaped graphite particles are added as a solid phase. The graphite particles are dispersed in the binding agent by means of a propeller stirrer at a rotational speed of 300 to 1500 rpm. Here, the material to be mixed is drawn-in from top to bottom and an axial flow is produced.

Step b) Production of the Electrically Conductive Coating

The coating material produced in a) is printed on the substrate in a partially structured manner by means of screen printing. Subsequently, the coated substrate is dried for 90 minutes at a temperature of 200° C. and burned-in for 90 minutes at 400° C.

### Example E

### Production of a Substrate with an Electrically Conductive Coating (Inorganic Binding Agent)

Step a) Preparation of the Coating Material

0.05 mole of p-toluenesulfonic acid is dissolved in 1.26 moles of tetraethoxysilane (TEOS) and the mixture is reacted with 1.76 mole of water. After the sol-gel reaction has begun, the mixture is heated to a temperature of >50° C.

After the sol-gel reaction has terminated, 153 g of terpineol and 38.3 g of n-butyl acetate are added to 300 g of the hydrolysate. Subsequently, the low-boiling solvent that has formed during the sol-gel reaction is removed on the rotary evaporator.

25 g of graphite are dispersed in 75 g of binding agent. Additionally, 0.2 to 0.5 g of defoamer, for example, a silicone oil, can be added.

First, the liquid phase is weighed-in; then the flake-shaped graphite particles are added as a solid phase. The graphite particles are dispersed in the binding agent by means of a propeller stirrer at a rotational speed of 300 to 1500 rpm. Here, the material to be mixed is drawn-in from top to bottom and an axial flow is produced, so that the locally occurring shearing forces are minimal.

Step b) Production of the Electrically Conductive Coating

The coating material produced in a) is printed on the substrate in a partially structured manner by means of screen printing. Subsequently, the coated substrate is dried for 90 minutes at a temperature of 200° C. and burned-in for 90 minutes at 400° C.

### Example F

### Production of a Substrate with an Electrically Conductive Coating (Polyester-Modified Silicone Resin)

Step a) Preparation of the Coating Compound

25 g of graphite are dispersed in 75 g of a binding agent with a polyester-modified silicone resin as the binding-agent matrix and a methoxypropyl acetate/xylene mixture as the solvent (Silikoftal® HTL-3 of Evonik Industrie AG) by means of a propeller stirrer at a rotational speed of 300 to 1500 rpm. Here, the material to be mixed is drawn-in from top to bottom and an axial flow is produced.

Step b) Production of the Electrically Conductive Coating

The coating compound produced in step a) is printed on the substrate in a partially structured manner by means of screen printing. Subsequently, the coated substrate is dried for 90 minutes at a temperature of 200° C. After drying, the coating is burned-in by heating the coated substrate for 90 minutes at a temperature of 400° C.

### Example G

### Production of a Substrate with an Electrically Conductive Coating (Epoxy-Modified Silicone Resin)

Step a) Preparation of the Coating Compound

25 g of graphite are dispersed in 75 g of a binding agent with an epoxy-modified silicone resin as the binding-agent matrix (Silikopon® EF of Evonik Industrie AG) by means of a propeller stirrer at a rotational speed of 300 to 1500 rpm. Here, the material to be mixed is drawn-in from top to bottom and an axial flow is produced.

Step b) Production of the Electrically Conductive Coating

The coating compound produced in step a) is printed on the substrate in a partially structured manner by means of screen printing. Subsequently, the coated substrate is dried for 90 minutes at a temperature of 200° C. After drying, the coating is burned-in by heating the coated substrate for 90 minutes at a temperature of 400° C.

What is claimed is:

1. A method for producing an electrically conductive coating on a substrate, comprising:
providing a binding agent, whereby the binding agent contains an inorganically crosslinked, SiO₂-based binding-agent matrix and an organic solvent;
producing a coating compound by dispersing an electrically conductive pigment in the binding agent by mechanical convection, wherein the electrically conductive pigment amounts to a fraction of 10 to 40 wt. %, and carbon is used as the electrically conductive pigment;
partial, structured printing of the coating compound onto the substrate to provide a coating; and
drying the coating at temperatures in the range of 20 to 250° C. to provide a dried coating.

2. The method according to claim 1, wherein the electrically conductive pigment comprises flake-shaped graphite particles.

3. The method according to claim 1, wherein the dispersing of the electrically conductive pigment in the binding agent by mechanical convection comprises a dispersing step selected from the group consisting of dispersing with a stirrer, dispersing with an axially-conveying stirrer, and dispersing with a propeller stirrer.

4. The method according to claim 1, wherein the dispersing of the electrically conductive pigment in the binding agent by mechanical convection comprises using a stirrer with a rotational speed of less than 3000 rpm.

5. The method according to claim 1, further comprising adding inorganic nanoparticles to the binding agent.

6. The method according to claim 2, wherein the flake-shaped graphite particles have a particle size d90 in the range of 1 to 100 μm.

7. The method according to claim 1, wherein the fraction of electrically conductive pigment in the coating compound is 10 to 35 wt. %.

8. The method according to claim 1, wherein the step of partial, structured printing of the coating compound onto the substrate comprises screen-printing of the coating compound onto the substrate.

9. The method according to claim 1, further comprising burning-in the dried coating at temperatures in the range of 100 to 500° C.

10. The method according to claim 1, wherein the electrically conductive pigment consists of flake-shaped graphite particles.

11. The method according to claim 1, wherein the binding agent is a sol-gel binding agent.

12. The method according to claim 11, wherein the sol-gel binding agent is produced by hydrolysis of at least one monomer, wherein an alcohol is formed and subsequently the formed alcohol is exchanged for the organic solvent, and an inorganic degree of crosslinking of the binding agent is adjusted by the ratio of water to monomer.

13. The method according to claim 12, wherein the monomers comprise materials selected from the group consisting of metal alkoxides, alkoxysilanes, trialkoxysilanes, tetraalkoxysilanes, and combinations thereof.

14. The method according to claim 12, wherein the sol-gel binding agent is produced by reaction of at least one monomer with water in the presence of a catalyst.

15. The method according to claim 14, wherein the catalyst is an acid.

16. The method according to claim 12, wherein the monomer is hydrolyzed in the presence of inorganic nanoparticles.

17. The method according to claim 12, wherein the inorganic degree of crosslinking of the binding-agent matrix is 40 to 90%.

18. The method according to claim 12, wherein the organic solvent of the binding agent has a property selected from the group consisting of a vapor pressure of <5 bars; a boiling point >120° C., an evaporation number >10, and combinations thereof.

19. The method according to claim 12, wherein the organic solvent is selected from the group consisting of a glycol, a glycol ether, a terpineol, a polyol, n-butyl acetate, methoxybutyl acetate, butyl diglycol, butyl diglycol acetate, cyclohexanone, diacetone alcohol, diethylene glycol, dipropylene glycol monomethyl ether, dipropylene glycol monobutyl ether, dipropylene glycol monopropyl ether, propylene glycol monobutyl ether, propylene glycol monopropyl ether, propylene glycol monoethyl ether, ethoxypropyl acetate, hexanol, methoxypropyl acetate, monoethylene glycol, ethyl pyrrolidone, propylene glycol, propylene glycol monomethyl ether, mixtures of paraffinic and naphthenic hydrocarbons, aromatic hydrocarbon mixtures, mixtures of aromatic, alkylated hydrocarbons, mixtures of n-, i- and cyclo-aliphates, terpineol, and combinations thereof.

20. The method according to claim 1, wherein the binding-agent matrix is selected from the group consisting of a silicone resin, an alkyl-modified silicone resin, an aryl-modified silicone resin, a methyl-modified silicone resin, a phenyl-modified silicone resin, and combinations thereof.

21. The method according to claim 20, wherein the binding-agent matrix comprises silicone resin containing epoxy and/or polyester groups.

22. A preparation for applying an electrically conductive coating onto a substrate, comprising a binding agent having an inorganically crosslinked, SiO₂-containing binding-agent matrix as well as carbon as an electrically conductive pigment, wherein the electrically conductive pigment amounts to a fraction of 10 to 40 wt. %, and the electrically conductive pigment is dispersed in the binding-agent matrix.

23. The preparation according to claim 22, wherein the fraction is 10 to 35 wt. %.

24. The preparation according to claim 22, wherein the electrically conductive pigment comprises flake-shaped graphite particles.

25. The preparation according to claim 24, wherein the flake-shaped particles have particle sizes d90 in the range of 1 to 100 μm.

26. The preparation according to claim 22, further comprising compounds selected from the group consisting of leveling agents, defoamers, deaerators, thickeners, hardeners, curing agents, initiators, corrosion inhibitors, adhesion promoters, surface reactants, surfactants, dispersing additives, and combinations thereof.

27. The preparation according to claim 22, further comprising a viscosity at a rotational speed of 140 rpm in a range of 1 to 20,000 cP.

28. The preparation according to claim 22, wherein the binding-agent matrix is a sol-gel binding-agent matrix.

29. The preparation according to claim 28, wherein the binding-agent matrix is an inorganic sol-gel binding-agent matrix.

30. The preparation according to claim 29, wherein the inorganic sol-gel binding-agent matrix has an inorganic degree of crosslinking of 40 to 90%.

31. The preparation according to claim 22, wherein the binding-agent matrix is selected from the group consisting of silicone resin, an alkyl-modified silicone resin, an aryl-modified silicone resin, a methyl-based silicone resin, a phenyl-based silicone resin, and combinations thereof.

32. The preparation according to claim 31, wherein the binding-agent matrix is silicone resin comprising epoxy and/or polyester groups.

33. A substrate comprising an electrically conductive, temperature-resistant coating, wherein the coating contains an inorganically crosslinked, SiO₂-containing matrix and flake-shaped graphite particles as an electrically conductive pigment, and wherein the flake-shaped graphite particles are dispersed in the inorganically crosslinked, SiO₂-containing matrix.

34. The substrate according to claim 33, wherein the coating contains only flake-shaped graphite particles as the electrically conductive pigment.

35. The substrate according to claim 33, wherein the coating is resistant to temperatures of at least 300° C.

36. The substrate according to claim 33, wherein the electrically conductive pigment is present in the coating in an amounts of 20 to 80 wt. %.

37. The substrate according to claim 33, wherein the graphite particles have a size d90 in the range of 1 to 100 μm.

38. The substrate according to claim 33, wherein the coating has a surface resistance of 5 to 1000 Ohms/square.

39. The substrate according to claim 33, wherein the coating has a layer thickness of 5 to 25 micrometers.

40. The substrate according to claim 33, wherein the coating has a scratch resistance of 500 to 1000 g.

41. The substrate according to claim 33, wherein the coating further comprises a material selected from the group consisting of inorganic nanoparticles, oxidic nanoparticles, and SiO₂ nanoparticles.

42. The substrate according to claim 33, wherein the substrate comprises glass or glass ceramic.

43. The substrate according to claim 42, wherein the glass or glass ceramic is transparent.

44. The substrate according to claim 33, wherein the substrate is an LAS glass ceramic containing high-quartz mixed crystals (HQMK) and/or keatite mixed crystals as a prevalent crystal phase.

45. The substrate according to claim 33, further comprising one or more additional layers selected from the group consisting of a functional layer, a dielectric layer, an anti-reflection layer, a decorative layer, a sealing layer, and a silicone-based layer, the one or more additional layers being disposed between the substrate and the coating.

46. The substrate according to claim 33, wherein the coating contains a sol-gel matrix.

47. The substrate according to claim 33, wherein the inorganically crosslinked, SiO₂-containing matrix has an inorganic degree of crosslinking of 40 to 90%.

48. The substrate according to claim 33, wherein the coating contains a silicone-resin matrix.

49. The substrate according to claim 48, wherein the silicone-resin matrix comprises a methyl-modified and/or a phenyl-modified silicone resin.

50. The substrate according to claim 48, wherein the silicone-resin matrix is organically crosslinked.
